(19) United States
(12) Patent Application Publication
(10) Pub. No.: US 2018/0199667 A1
(43) Pub. Date: Jul. 19, 2018

(54) SOLE STRUCTURE WHICH HAS DISTINGUISHED THREE-DIMENSIONAL PATTERNS

(71) Applicant: CHAEI HSIN ENTERPRISE CO., LTD., Taichung City (TW)

(72) Inventor: Shui Mu WANG, Taichung City (TW)

(21) Appl. No.: 15/407,048

(22) Filed: Jan. 16, 2017

(51) Int. Cl. A43B 13/32; A43B 13/04; A43B 13/12; A43B 13/22; A43B 3/00; B29D 35/14

(52) U.S. Cl. CPC A43B 13/32; A43B 13/04; A43B 13/12; B29K 2105/04; A43B 3/0063; B29D 35/142; A43B 13/22

(57) ABSTRACT

A sole structure contains: a body and at least one external layer. The body is formed in a foam molding manner and corresponds to human foot, and the body includes multiple three-dimensional ribs and at least one three-dimensional pattern portion. Each of the at least one external layer includes a protective part arranged on an outer wall thereof, and each external layer includes a connection part arranged on an inner wall thereof. The connection part is heated to melt and to adhere with an inner wall of the body, and the at least one external layer is fixed on the body and is heated and vacuumed so as to matingly adhere with the multiple three-dimensional ribs and the at least one three-dimensional pattern portion.

### FIELD OF THE INVENTION

The present invention relates to a sole structure which has distinguished three-dimensional patterns and abrasion resistance.

### BACKGROUND OF THE INVENTION

A conventional shoe sole is not waterproof and is abraded easily, thus decreasing service life. Furthermore, the conventional shoe sole fades easily after a period of using time.

An improved sole structure is disclosed in TW Publication No. 00583919 and contains a body and a thermoplastic polyurethane urethane (TPU) film which adheres with the body, after the TPU film is hot pressed and melts. However, when the body has a bumpy outer surface or patterns, the TPU film cannot matingly adhere with the body, hence gaps produce between the TPU film and the body, and water flows into the gaps easily. Furthermore, the TPU film is so thick that the improved sole structure cannot have distinguished patterns.

The present invention has arisen to mitigate and/or obviate the afore-described disadvantages.

### SUMMARY OF THE INVENTION

The primary objective of the present invention is to provide a sole structure which has distinguished three-dimensional patterns and abrasion resistance.

Another objective of the present invention is to provide a sole structure which is water proof and avoids air trap.

To obtain above-mentioned objectives, a sole structure provided by the present invention contains: a body and at least one external layer.

The body is formed in a foam molding manner and corresponds to human foot, and the body includes multiple three-dimensional ribs and at least one three-dimensional pattern portion.

Each of the at least one external layer includes a protective part arranged on an outer wall thereof, and each external layer includes a connection part arranged on an inner wall thereof.

The connection part is heated to melt and to adhere with an inner wall of the body, and the at least one external layer is fixed on the body and is heated and vacuumed so as to matingly adhere with the multiple three-dimensional ribs and the at least one three-dimensional pattern portion.

### BRIEF DESCRIPTION OF THE DRAWINGS

FIG. 1 is a perspective view showing the exploded components of a sole structure according to a preferred embodiment of the present invention.

FIG. 2 is a perspective view showing the assembly of the sole structure according to the preferred embodiment of the present invention.

FIG. 3 is a cross sectional view showing the operation of the sole structure according to the preferred embodiment of the present invention.

FIG. 4 is another cross sectional view showing the operation of the sole structure according to the preferred embodiment of the present invention.

### DETAILED DESCRIPTION OF THE PREFERRED EMBODIMENTS

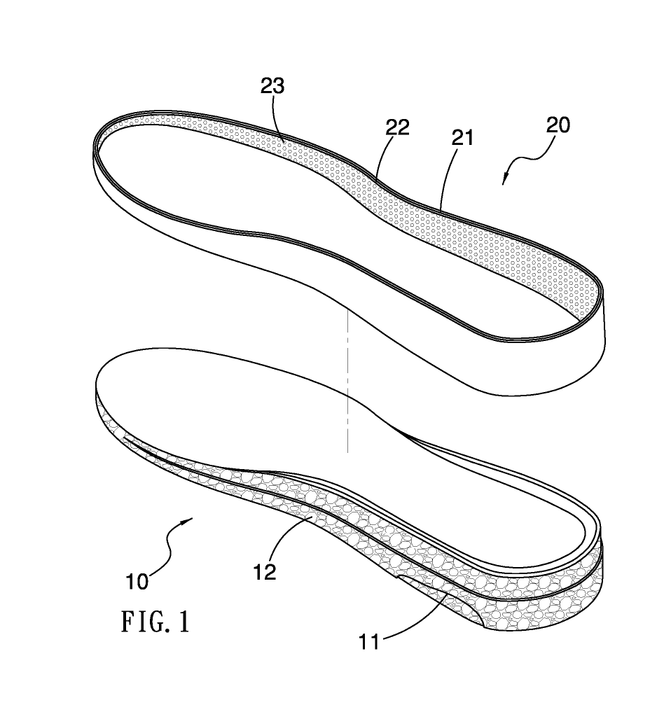

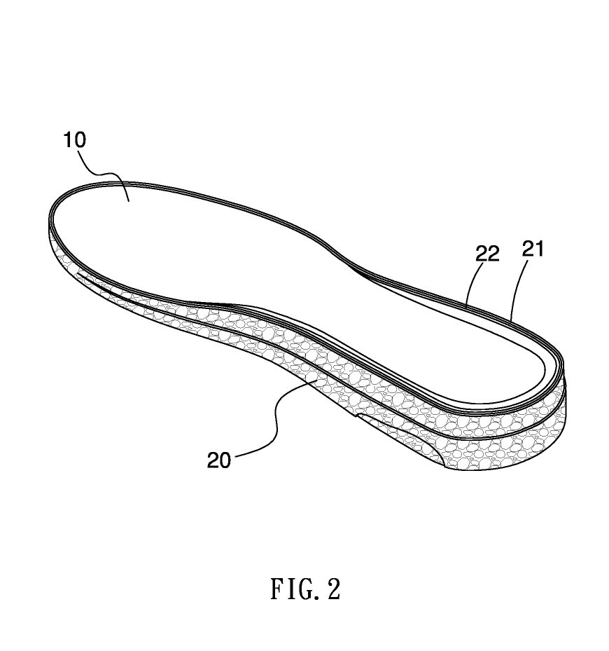

With reference to FIGS. 1-4, a sole structure according to a preferred embodiment of the present invention comprises: a body 10 and at least one external layer 20.

The body 10 is formed in a foam molding manner (such as infusion foaming, fill foaming, hot press foaming or injection foaming manner) and corresponds to human foot, and the body 10 includes multiple three-dimensional ribs 11 and at least one three-dimensional pattern portion 12. The body 10 is made of any one of polyurethane (PU), ethylene vinyl acetate (EVA), thermoplastic polyurethane urethane (TPU), thermo plastic rubber (TPR), acrylonitrile butadiene styrene (ABS), polycarbonate (PC) and rubber.

Each of the at least one external layer 20 is an annular sheet and includes a protective part 21 arranged on an outer wall thereof and includes a connection part 22 arranged on an inner wall of each external layer 20. The protective part 21 is made of any one of fabric, artificial leather, rubber film, plastic film, color film and animal leather (such as ostrich skin), and the connection part 22 is hot melt adhesive which is heated to melt and to adhere with an inner wall of the body 10. The connection part 22 has multiple raised portions 23 formed on an inner wall thereof, and each of the multiple raised portions 23 is any one of a ball, an elongated strip, and a protrusion. Thereby, each external layer 20 is fixed on the body 10 and is heated and vacuumed so as to matingly adhere with the multiple three-dimensional ribs 11 and the at least one three-dimensional pattern portion 12. A thickness of the protective part 21 is at least 10 um, and a hardness of the protective part 21 is Shore A30 to Shore D72, wherein the protective part 21 is heated by using an electric heater or a hot air heater. In this embodiment, each external layer 20 is in a U shape or in a sheet shape.

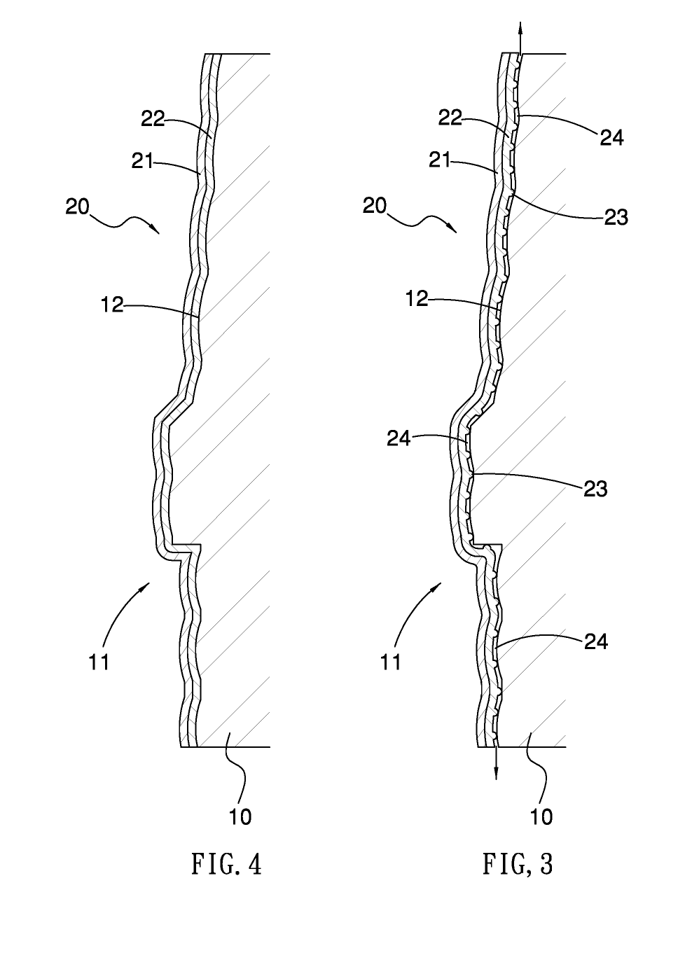

Referring to FIG. 3, when each external layer 20 is fixed on the body 10 and is heated and vacuumed, the multiple raised portions 23 abut against the body 10 so that multiple channels 24 are formed between the connection part 22 and the body 10, wherein the multiple channels 24 are in communication with one another, hence when the multiple raised portions 23 melt after being heated, air in the multiple channels 24 are vacuumed so that each external layer 20 matingly adheres with the multiple three-dimensional ribs 11 and the at least one three-dimensional pattern portion 12, thus avoiding air trap in the sole structure. Preferably, distinguished three-dimensional patterns produce between each external layer 20 and the body 10, as shown in FIG. 4.

In addition, the sole structure of the present invention is waterproof and has abrasion resistance by way of each external layer 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A sole structure comprising:
a body formed in a foam molding manner and corresponding to human foot, and the body including multiple three-dimensional ribs and at least one three-dimensional pattern portion;
at least one external layer, each of the at least one external layer including a protective part arranged on an outer wall thereof, and each external layer also including a connection part arranged on an inner wall of each external layer;
wherein the connection part is heated to melt and to adhere with an inner wall of the body, and each external layer is fixed on the body and is heated and vacuumed so as to matingly adhere with the multiple three-dimensional ribs and the at least one three-dimensional pattern portion.

2. The sole structure as claimed in claim 1, wherein the foam molding manner is any one of infusion foaming manner, fill foaming manner, hot press foaming manner, and injection foaming manner.

3. The sole structure as claimed in claim 1, wherein each external layer is an annular sheet.

4. The sole structure as claimed in claim 1, wherein each external layer is in a U shape.

5. The sole structure as claimed in claim 1, wherein each external layer is in a sheet shape.

6. The sole structure as claimed in claim 1, wherein the protective part is made of any one of fabric, artificial leather, rubber film, plastic film, color film and animal leather.

7. The sole structure as claimed in claim 1, wherein the connection part is hot melt adhesive.

8. The sole structure as claimed in claim 1, wherein the connection part has multiple raised portions formed on an inner wall thereof, and when each external layer is fixed on the body, the multiple raised portions abut against the body so that multiple channels are formed between the connection part and the body, wherein the multiple channels are in communication with one another, and when the multiple raised portions melt after being heated, air in the multiple channels are vacuumed so that each external layer matingly adheres with the multiple three-dimensional ribs and the at least one three-dimensional pattern portion.
